(19) United States
(12) Patent Application Publication
(10) Pub. No.: US 2025/0254037 A1
(43) Pub. Date: Aug. 7, 2025

(54) TRANSPARENT TRANSPORTATION IN CLOUD-TO-PC EXTENSION FRAMEWORK

(71) Applicant: Intel Corporation, Santa Clara, CA (US)

(72) Inventors: Juan Zhao, Shanghai (CN); Arvind Kumar, Beaverton, OR (US); Curtis Jutzi, Lake Oswego, OR (US); Wenqing Fu, Portland, OR (US); Junyong Ding, Shanghai (CN); Huifeng Le, Shanghai (CN); Bing Zhu, Shanghai (CN)

(73) Assignee: Intel Corporation, Santa Clara, CA (US)

(21) Appl. No.: 18/855,788

(22) PCT Filed: May 31, 2022
(86) PCT No.: PCT/CN2022/096215

§ 371 Date: Oct. 10, 2024

(51) Int. Cl. H04L 9/08

(52) U.S. Cl. CPC H04L 9/088

(57) ABSTRACT

An apparatus to facilitate transparent transportation in cloud-to-PC extension framework is disclosed. The apparatus includes one or more processors to generate, using a cloud-to-PC extension framework (CPEF) edge component, a root key of the CPEF edge component, wherein the CPEF edge component is trusted; deploy, using the CPEF edge component, a microservice container to locally host functionality of a microservice of an application, wherein the application is hosted remotely from the apparatus; initialize a sidecar for the microservice container; generate, by the sidecar, a client signed key using at least one of the root key and a hostname of the microservice; provide, by the sidecar, the client signed key to the microservice container; and redirect requests for the microservice to the microservice container, the requests originating from an accessing application of the apparatus, the requests redirected through a secure communication channel that is trusted based on the client signed key.

### FIELD

Embodiments relate generally to data processing and more particularly to transparent transportation in cloud-to-PC extension framework.

### BACKGROUND OF THE DESCRIPTION

Datacenters often leverage a microservice architecture to provide for network infrastructure services. A microservice architecture can arrange an application as a collection of loosely-coupled microservices. Microservices can refer to processes that communicate over a network to fulfill a goal using technology-agnostic protocols. In some cases, the microservices may be deployed using a container orchestration platform providing containerized workloads and/or services. The container orchestration platforms may utilize a service mesh to manage the high volume of network-based inter-process communication among the microservices. The service mesh is a dedicated software infrastructure layer for the microservices that includes elements to enable the communication among the microservices to be fast, reliable, and secure. The service mesh provides capabilities including service discovery, load balancing, encryption, observability, traceability, and authentication and authorization. The microservices deployment model provided by the service mesh is becoming increasingly elastic, providing flexibility to scale up and scale down microservices.

In some cases, the microservices architecture utilize a cloud-to-PC (personal computer) extension framework (such as Cloud-First Client, Dynamic Endpoint Orchestration, etc.) may be implemented to leverage the computing resources of both the datacenter and client devices. The cloud-to-PC extension framework can enable microservice containers of the service mesh to be deployed on the client-side, as well as in the datacenter of the cloud.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate typical embodiments and are therefore not to be considered limiting of its scope. The figures are not to scale. In general, the same reference numbers are used throughout the drawing(s) and accompanying written description to refer to the same or like parts.

FIG. 1 illustrates a block diagram of components of a client device in a networking system, according to implementations herein.

FIG. 2 is a block diagram of a computing device implementing transparent transportation in a cloud-to-PC (personal computer) extension framework, in accordance with implementations herein.

FIGS. 3A and 3B are block diagrams illustrating transparent transportation in a cloud-to-PC extension framework utilizing different keys, in accordance with implementations herein.

FIG. 4 is a block diagram depicting a networking system implementing transparent transportation in a cloud-to-PC extension framework, in accordance with implementations herein.

FIG. 5 is a flow diagram illustrating an embodiment of a method for transparent transportation in cloud-to-PC extension framework using a locally-generated client signed key.

FIG. 6 is a flow diagram illustrating an embodiment of a method for transparent transportation in cloud-to-PC extension framework using remote attestation.

FIG. 7 is a schematic diagram of an illustrative electronic computing device to enable transparent transportation in cloud-to-PC extension framework, in accordance with implementations herein.

### DETAILED DESCRIPTION

Implementations of the disclosure describe transparent transportation in cloud-to-PC (personal computer) extension framework.

Independent software vendors (ISVs) leverage the power of the cloud to deploy services of their applications. In order to host the services of their applications, ISVs can utilize a datacenter hosted by the cloud service provider (CSP) to deploy their application(s) to customers. In some cases, the CSP implements a service mesh to leverage a microservice architecture to provide for network infrastructure services of the service mesh. A microservice architecture can arrange an application as a collection of loosely-coupled microservices. The microservices may be the processes that communicate over a network to fulfill a goal using technology-agnostic protocols. In some cases, the microservices can be deployed using a container orchestration platform providing containerized workloads and/or services. In some examples, the service may be a large service comprising hundreds of microservices working in conjunction with each other or may be a modest individual service. A workload may refer to a resource running on the cloud consuming resources, such as computing power. In some embodiments, an application, service, or microservice may be referred to as a workload, which denotes the workload can be moved around between different cloud platforms or from on-premises to the cloud or vice-versa without any dependencies or hassle.

The container orchestration platforms may utilize a service mesh to manage the high volume of network-based inter-process communication among the microservices. The service mesh is a dedicated software infrastructure layer for the microservices that includes elements to enable the communication among the microservices to be fast, reliable, and secure. The service mesh provides capabilities including service discovery, load balancing, encryption, observability, traceability, and authentication and authorization.

In some cases, the microservices architecture utilize a cloud-to-PC extension framework (such as Cloud-First Client, Dynamic Endpoint Orchestration, etc.) may be implemented to leverage the computing resources of both the datacenter and client devices. Although the term PC is utilized herein, the extension framework may apply between a cloud device and any form of client or server device in implementations herein. The cloud-to-PC extension framework can enable microservice containers of the service mesh to be deployed on the client-side, as well as in the datacenter of the cloud.

In the cloud-to-PC extension framework, microservice deployment can switch between a cloud deployment (remotely on a server device) and a client deployment (locally on the client device). The cloud-to-PC extension framework may have three different components: the ISV, a cloud-to-PC extension framework controller, and a cloud-to-PC extension framework edge client. When seeking to deploy a microservice to a client device, the cloud-to-PC extension framework controller can provide to the cloud-to-PC extension framework edge client a service manifest that identifies microservice(s) to be deployed at the client and a location to be deploy the microservice(s) as containers.

In the case of a local client deployment of a microservice container, the application's connection to the microservice should be a secure connection. One example for implementing a secure connection is the QUIC protocol, which combines User Datagram Protocol (UDP) and Transport Layer Security (TLS). This secure connection should also be maintained within the client (e.g., secure connection within the client device between a web application (webapp)/browser and the local microservice container). Maintaining a secure connection, such as a QUIC protocol connection, between the webapp/browser and the local microservice container within the client device protects the communications so that other microservices (e.g., from other clients or other applications) cannot access the data of the microservice. Furthermore, extending the same secure connection within the client device avoids having to change the communication protocol used by the application and the ISV.

An example communication connection process that may occur during local client deployment of a microservice container can proceed as follows. First, a browser (of the client device) visits https://aaa.com to start the service. In the example, a microservice of the service of aaa.com, such as “micro-service.aaa.com” may be utilized to handle an example background removal operation for the service. In this case, the connection between the browser and micro-service.aaa.com can be utilizing the QUIC secure transportation protocol. Subsequently, the cloud-to-PC extension framework prepares the micro-service.aaa.com locally (via local deployment of a microservice container) and redirects the micro-service.aaa.com to the local client service microservice container. At this point, the browser should set up a secure connection (e.g., QUIC) with the local micro-service.aaa.com.

The last step of the process, where the browser is to set up the secure connection with the local microservice container, can be a complex process as it utilizes mutual trust between the browser and micro-service.aaa.com. Furthermore, this step utilizes two separate TLS connection set-up procedures. As such, an approach is needed to setup a secure connection (e.g., QUIC connection) for browser and the client micro-service.aaa.com in a transparent manner, so that no changes have to be made to the webapp/browser and the microservice to establish the secure connection.

One conventional approach may be to use the cloud private key signed by the ISV. The ISV's cloud private key is transported to the client through public network. However, this approach introduces security concerns as the cloud private key is transported over the public network environment, which is insecure.

Another conventional approach is to utilize a signed local micro-service container and then the signed local micro-service communicates to ISV server directly. However, this approach has the technical disadvantage it does not transparently establish the secure connection between the browser and the local micro-service.aaa.com. Instead, this approach customizes the webapp/browser and microservice.aaa.com. Specifically, this approach introduces complexity because it utilizes special customization for the webapp/browser and ISV's microservice. Meanwhile, secure communication inside the cluster is not addressed. Extra work is utilized to secure the data transportation from webapp/browser to local micro-service.aaa.com.

Implementations of the disclosure address the above-noted technical drawbacks by providing for transparent transportation in cloud-to-PC extension framework. In implementations herein, techniques are provided for establishing a secure connection (e.g., QUIC connection) between a webapp/browser and a local microservice deployed on a client device as part of a cloud-to-PC extension framework. The secure connection is established transparently (“transparent transportation”), which means that no changes are made to the webapp/browser and the local microservice in order to establish the secure connection.

In implementations herein, as part of deploying an application's microservice locally at a client device (e.g., as a microservice container) using a cloud-to-PC extension framework, a cloud-to-PC extension framework edge component (at the client device) can adopt/standardize a key injection process and leverage a client signed key in the client side. In one implementation, the key injection process can utilize a sidecar (service mesh) for both the cloud microservice and the client microservice deployments. A different key is used for the microservice in the cloud or the client. For example, an ISV

Cloud-Key is used on the Cloud side, and a Client-Signed-Key is used on the client side. In implementations herein, the Client-Signed-Key is signed with a cloud-to-PC extension framework Root key, that is maintained at and trusted by the client system. The webapp/browser trusts the cloud-to-PC extension framework Root key. The cloud-to-PC extension framework can use this Root Key and the hostname (e.g., “micro-service.aaa.com”) to sign the Client-Signed-Key. The sidecar then injects this key to the local micro-service.aaa.com. The term ‘injection’ may refer to the passing of a dependency (a service) into the client that uses it. The service is made part of the client's state. Passing the service to the client, rather than allowing the client to build or find the service, is a significant component of the pattern.

The key generation and injection inside the sidecar are protected by a confidential compute architecture, such as Intel® Trust Domain extension (TDX). In some implementations, the client side can also adopt remote attestation with to verify a key generated by ISV. This may be utilized for cases where the ISV prefers to provide keys for each client.

Implementations of the discosure provide technical advantages over the conventional approaches discussed above. One technical advantage is that implementations allow for the secure connection and transportation of microservice data to be transparent. This allows for secure communication in the client application/browser and microservice in the server and client. It further simplifies the microservice's deployment at the client device by standardizing the key injection. In addition, implementations address the un-secure local communication by extending certificate authority (CA)/key generation.

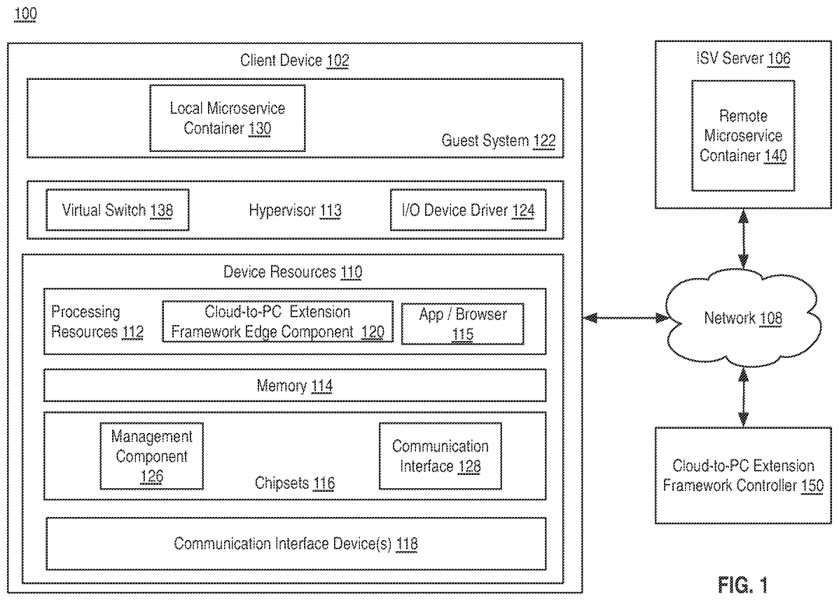

FIG. 1 illustrates a block diagram of components of a client device 102 in a networking system 100, according to implementations herein. In the embodiment depicted, client device 102, along with an ISV server 106 and cloud-to-PC extension framework controller 150 are interconnected via network 108. In other embodiments, a computer system may include any suitable number of (i.e., one or more) platforms.

A client device 102 may include device resources 110 with one or more processing resources 112 (e.g., XPUs including CPUs, GPUs, FPGAs, ASICs, other hardware accelerators), memories 114 (which may include any number of different modules), chipsets 116, communication interface device(s) 118, and any other suitable hardware and/or software to execute a hypervisor 113 or other operating system capable of executing workloads associated with applications running on client device 102.

In some embodiments, a client device 102 may function as a host platform for one or more guest systems 122 that invoke these applications. Client device 102 may represent any suitable computing environment, such as a laptop, a desktop, a mobile computing device, a handheld computing device, a server, a high-performance computing environment, a data center, a communications service provider infrastructure (e.g., one or more portions of an Evolved Packet Core), an in-memory computing environment, a computing system of a vehicle (e.g., an automobile or airplane), an Internet of Things (IoT) environment, an industrial control system, other computing environment, or combination thereof. In some embodiments, a client device 102 may reside on a circuit board that is installed in a chassis, rack, or other suitable structure that comprises multiple platforms coupled together through network 108 (which may comprise, e.g., a rack or backplane switch).

Device resources 110 can include, among other logic enabling the functionality of client device 102, one or more processing resources 112 (such as CPUs, GPUs, FPGAs, other hardware accelerators, etc.), memory 114, one or more chipsets 116, and communication interface devices 128. In the case of processing resources 112 comprising CPUs, the CPUs may each comprise any suitable number of processor cores and supporting logic (e.g., uncores). The cores may be coupled to each other, to memory 114, to at least one chipset 116, and/or to a communication interface device 118, through one or more controllers residing on the processing resource 112 (e.g., CPU) and/or chipset 116. In some embodiments, a processing resource 112 is embodied within a socket that is permanently or removably coupled to client device 102. Client device 102 may include any suitable number of processing resources 112.

Memory 114 may comprise any form of volatile or nonvolatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long term storage by client device 102. Memory 114 may store any suitable data or information utilized by device resources 110, including software embedded in a computer readable medium, and/or encoded logic incorporated in hardware or otherwise stored (e.g., firmware). Memory 114 may store data that is used by cores of processing resources 112. In some embodiments, memory 114 may also comprise storage for instructions that may be executed by the processing resources 112 (e.g., cores of CPUs) or other processing elements (e.g., logic resident on chipsets 116) to provide functionality associated with the management component 126 or other components of device resources 110.

Client device 102 may also include one or more chipsets 116 comprising any suitable logic to support the operation of the processing resources 112. In various embodiments, chipset 116 may reside on the same die or package as a processing resource 112 or on one or more different dies or packages. Each chipset may support any suitable number of processing resources 112. A chipset 116 may also include one or more controllers to couple other components of device resources 110 (e.g., communication interface device 128 or memory 114) to one or more processing resources 112.

In the embodiment depicted, each chipset 116 also includes a management component 126. Management component 126 may include any suitable logic to support the operation of chipset 116. In a particular embodiment, a management component 126 can collect real-time telemetry data from the chipset 116, the processing resources 112, and/or memory 114 managed by the chipset 116, other components of device resources 110, and/or various connections between components of device resources 110.

Chipsets 116 also each include a communication interface device 128. Communication interface device 128 may be used for the communication of signaling and/or data between chipset 116 and one or more I/O devices, one or more networks 108, and/or one or more devices coupled to network 108. For example, communication interface device 128 may be used to send and receive network traffic such as data packets. In a particular embodiment, a communication interface device 128 comprises one or more physical network interface controllers (NICs), also known as network interface cards or network adapters. A NIC may include electronic circuitry to communicate using any suitable physical layer and data link layer standard such as Ethernet (e.g., as defined by an IEEE 802.3 standard), FibreChannel, InfiniBand, Wi-Fi, or other suitable standard. A NIC may include one or more physical ports that may couple to a cable (e.g., an Ethernet cable). A NIC may enable communication between any suitable element of chipset 116 (e.g., management component 126) and another device coupled to network 108. In various embodiments, a NIC may be integrated with the chipset 116 (i.e., may be on the same integrated circuit or circuit board as the rest of the chipset logic) or may be on a different integrated circuit or circuit board that is electromechanically coupled to the chipset.

Device resources 110 may include an additional communication interface 128. Similar to communication interface devices 118, communication interfaces 128 may be used for the communication of signaling and/or data between device resources 110 and one or more networks 108 and one or more devices coupled to the network 108. For example, communication interface 128 may be used to send and receive network traffic such as data packets. In a particular embodiment, communication interfaces 128 comprise one or more physical NICs. These NICs may enable communication between any suitable element of device resources 110 (e.g., processing resources 112 or memory 114) and another device coupled to network 108 (e.g., elements of other platforms or remote computing devices coupled to network 108 through one or more networks).

Device resources 110 may receive and perform any suitable types of workloads. A workload may include any request to utilize one or more resources of device resources 110, such as one or more cores or associated logic. For example, a workload may comprise a request to instantiate a software component, such as an I/O device driver 124 or guest system 122; a request to process a network packet received from a microservice container 130 (or device external to client device 102 (such as a network node coupled to network 108); a request to execute a process or thread associated with a guest system 122, an application running on client device 102, a hypervisor 113 or other operating system running on client device 102; or other suitable processing request.

A local microservice container 130 may emulate a computer system with its own dedicated hardware. A container, such as local microservice container 130, may refer to a standard unit of software that packages up code and all its dependencies, so the application runs quickly and reliably from one computing environment to another. A container image is a lightweight, standalone, executable package of software that includes components used to run an application: code, runtime, system tools, system libraries and settings. Local microservice container 130 can take advantage of a form of operating system (OS) virtualization in which features of the OS are leveraged to both isolate processes and control the amount of CPU, memory, and disk that those processes have access to.

When implementing containers 130, hypervisor 113 may also be referred to as a container runtime. Although implementations herein discuss virtualization of microservice functionality via containers, in some implementations, virtual machines may be hosted by hypervisor 113 and utilized to host microservices and/or other components of a service provided by an application.

A hypervisor 113 (also known as a virtual machine monitor (VMM)) may comprise logic to create and run guest systems 122. The hypervisor 113 may present guest operating systems run by virtual machines with a virtual operating platform (i.e., it appears to the virtual machines that they are running on separate physical nodes when they are actually consolidated onto a single hardware platform) and manage the execution of the guest operating systems by device resources 110. Services of hypervisor 113 may be provided by virtualizing in software or through hardware-assisted resources that utilize minimal software intervention, or both. Multiple instances of a variety of guest operating systems may be managed by the hypervisor 113. In implementations herein, the hypervisor 113 may also be implemented as a container runtime environment capable of building and containerizing applications.

Hypervisor 113 may be a native or bare-metal hypervisor that runs directly on device resources 110 to control the platform logic and manage the guest operating systems. Alternatively, hypervisor 113 may be a hosted hypervisor that runs on a host operating system and abstracts the guest operating systems from the host operating system. Hypervisor 113 may include a virtual switch 138 that may provide virtual switching and/or routing functions to virtual machines of guest systems 122.

Virtual switch 138 may comprise a software element that is executed using components of device resources 110. In various embodiments, hypervisor 113 may be in communication with any suitable entity (e.g., a SDN controller) which may cause hypervisor 113 to reconfigure the parameters of virtual switch 138 in response to changing conditions in client device 102 (e.g., the addition or deletion of a local microservice container 130 or identification of optimizations that may be made to enhance performance of the platform).

The elements of device resources 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus, to name a few examples.

Elements of the client device 102 may be coupled together in any suitable manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices.

In implementations herein, local microservice container 130 may be deployed by a cloud-to-PC extension framework edge component 120 hosted by processing resources 112. Cloud-to-PC extension framework edge component 120 can enable local deployment of a microservices container (as local microservices container 130) of an application accessed by application/browser 115. Application (e.g., webapp) or browser 115 may be hosted by processing resources 112 of client device 102 and can provide the client device 102 access to an application hosted by ISV server 106. As part of a cloud-to-PC extension framework architecture, a cloud-to-PC extension framework controller 150, can provide to the cloud-to-PC extension framework edge component 120 a service manifest that identifies microservice(s) of the application to be deployed at the client device 102, as well as a location to deploy the microservice(s) as containers (e.g., as local microservice container 130).

As previously discussed, in the case of a local deployment of the local microservice container 130, the application/browser's 115 connection to the microservice should be a secure connection. One example for implementing a secure connection is the QUIC protocol. However, other secure connection protocols may also be utilized by implementations herein. Maintaining a secure connection, such as a QUIC protocol connection, between the webapp/browser 115 and the local microservice container 130 within the client device 102 protects the communications so that other microservices (e.g., from other clients or other applications) cannot access the data of the microservice. Furthermore, extending the same secure connection within the client device 102 can avoid having to change the communication protocol used by the application/browser 115 and the ISV server 106.

An example communication connection process that may occur during local client deployment of a microservice container can proceed as follows. First, app/browser 115 can access a network location (for example: https://aaa.com) of the ISV server 106 to start a service. In the example, a remote microservice container 140 of the service aaa.com, such as “micro-service.aaa.com”, may be utilized to handle an example background removal operation for the service at ISV server 106. In this case, the connection between the app/browser 115 and remote microservice container 140 (micro-service.aaa.com) may utilize a secure transportation protocol, such as QUIC protocol. Subsequently, the cloud-to-PC extension framework edge component 120 prepares the micro-service.aaa.com locally (via local deployment of local microservice container 130) and redirects requests for the micro-service.aaa.com to the local client service microservice container 130. At this point, the app/browser 115 should set up a secure connection (e.g., QUIC) with the local microservice container 130 for micro-service.aaa.com.

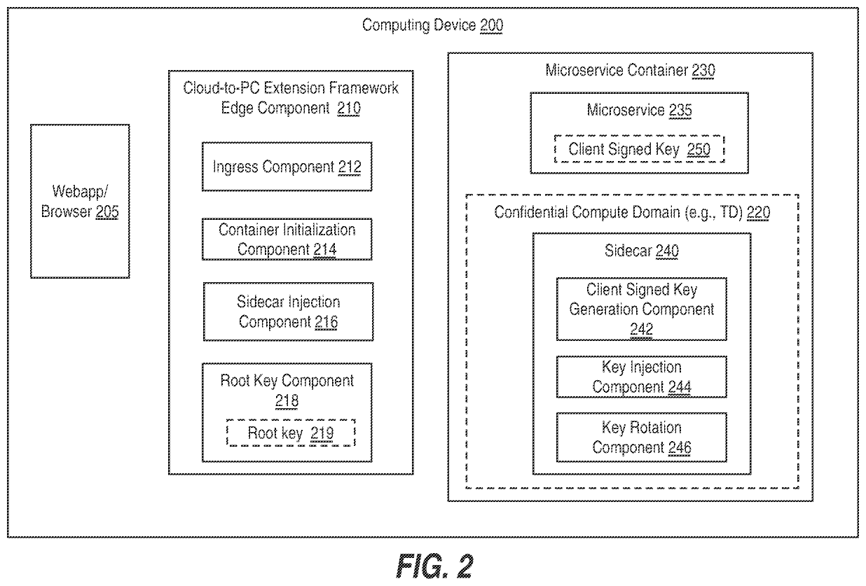

Further details of how the secure connection between app/browser 115 and local microservice container 130 is established and utilized for transparent transportation in implementations herein are described below with respect to FIGS. 2-7.

FIG. 2 is a block diagram of a computing device 200 implementing transparent transportation in a cloud-to-PC extension framework, in accordance with implementations herein. In one implementation, computing device 200 is the same as client device 102 described with respect to FIG. 1.

Computing device 200 may function as a host platform for an application or service, implementing deployed microservices of the application/service as one or more microservice containers 230 that invoke functionalities of the application/service. Computing device 200 may represent any suitable computing environment, such as a high-performance computing environment, a data center, a communications service provider infrastructure (e.g., one or more portions of an Evolved Packet Core), an in-memory computing environment, a computing system of a vehicle (e.g., an automobile or airplane), an Internet of Things (IoT) environment, an industrial control system, other computing environment, or combination thereof.

In one implementation, computing device 200 may host a cloud-to-PC extension framework edge component 210 and at least one microservice container 230. In one implementation, cloud-to-PC extension framework edge component 210 is the same as cloud-to-PC extension framework edge component 120 described with respect to FIG. 1. In one implementation, microservice container 230 is the same as local microservice container 130 described with respect to FIG. 1.

The cloud-to-PC extension framework enables an application (or a service) that is implemented with one or more microservice containers in a cloud environment to deploy at least one of the microservice containers to a client device, such as computing device 200, as microservice container 230. The local deployment of the microservice container 230 for the application may be orchestrated and managed using cloud-to-PC extension framework edge component 210. More generally, an example cloud-to-PC extension framework edge component 210 may be implemented by hardware, software, firmware and/or any combination of hardware, software and/or firmware. Thus, for example, the cloud-to-PC extension framework edge component 210 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). Cloud-to-PC extension framework edge component 210 may located at the same nodes or on a different node of microservice container 230 in the computing device 200.

In implementations herein, microservice container 230 may be implemented using hardware circuitry, such as one or more of a CPU, a GPU, a hardware accelerator, and so on. Although a single microservice container 230 is depicted in FIG. 2, more than one microservice container 230 may be deployed on computing device 200 in implementations herein.

In one implementation, cloud-to-PC extension framework edge component 210 operates to control management and/or orchestration of resources, such as microservice 230, for a service of a service mesh hosted by a networking system, such as networking system 100 of FIG. 1. In implementations herein, cloud-to-PC extension framework edge component 210 and the microservice container 230 provide for transparent transportation in a cloud-to-PC extension framework. Cloud-to-PC extension framework edge component 210 may manage the setup and establishment of a secure communication connection for the deployed microservice container 230 on computing device 200.

An example communication connection process that may occur during local deployment of a microservice container 230 can proceed as follows. First, webapp/browser 205 can access a network location of a server hosting a service of the application. In this case, the connection between the webapp/browser 205 and remote microservice container may utilize a secure transportation protocol, such as QUIC protocol. Subsequently, the cloud-to-PC extension framework edge component 210 prepares the microservice 235 locally (via local deployment of local microservice container 230) and redirects requests for the microservice 235 to the local microservice container 230.

In implementations herein, the cloud-to-PC extension framework edge component 210 can establish a secure communication connection that allows for transparent transportation of application data to the local microservice container 230. Cloud-to-PC extension framework edge component 210 may include one or more components to support transparent transportation in a cloud-to-PC extension framework. These components can include an ingress component 212, a container initialization component 214, a sidecar injection component 216, and a root key component 218.

In implementations herein, the container initialization component 214 may receive a manifest that identifies one or more microservices of an application that are to be deployed locally at the computing device 200. The container initialization component 214 may then cause the microservice container 230 to be deployed on computing device 200 to hose microservice 235 functionality. As part of deploying the microservice 235 locally at the microservice container 230, the cloud-to-PC extension framework edge component 210 can utilize a key injection process and leverage a client signed key. In one implementation, the key injection process includes the sidecar injection component 216 causing a sidecar 240 to be initialized for the microservice container 230. In one implementation, the sidecar 240 is implemented in a confidential compute domain 220 (e.g., a trust domain (TD)), using a confidential compute architecture, such as TDX.

A sidecar 240 can be a container that runs on the same pod as the microservice 235. As depicted herein, sidecar 240 is illustrated as part of the microservice container 230, but sidecar 240 may be implemented as a separate container than the microservice container 230 hosting microservice 235 functionality in some implementations. Sidecar 240 may include one or more components to support transparent transportation in a cloud-to-PC extension framework. These components can include a client signed key generation component 242, a key injection component 244, and a key rotation component 246.

In implementations herein, the sidecar 240 can implement client signed key generation component 242 to generate a client signed key 250 (“Client-Signed-Key”) for the microservice container 230. In implementations herein, the client signed key 250 is signed with a cloud-to-PC extension framework Root key 219 that is maintained by root key component 218 of cloud-to-PC extension framework edge component 210, which is trusted by the computing device 200. As such, the webapp/browser 205 trusts the cloud-to-PC extension framework Root key 219. The client signed key generation component 242 of sidecar 240 can use this Root Key 219 and a hostname of the application (or service) to sign the client signed key. The key injection component 244 of sidecar 240 then injects the client signed key 250 to the local microservice 235 of microservice container 230. In one implementation, the key rotation component 246 of sidecar 240 can cause the client signed key generation component 242 to periodically generate new and/or updated client signed keys for the microservice 235. In implementations herein, the key generation (by client signed key generation component 242) and injection (by key injection component 2442) inside the sidecar 240 are protected by a confidential compute domain 220 (e.g., a TD) of a confidential compute architecture, such as Intel® TDX.

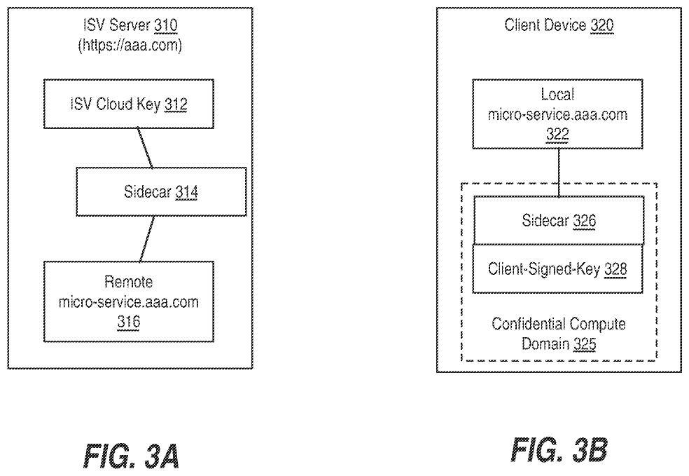

FIGS. 3A and 3B are block diagrams illustrating transparent transportation in a cloud-to-PC extension framework utilizing different keys, in accordance with implementations herein. FIG. 3A depicts an ISV server 310 hosting a remote microservice, such as remote micro-service.aaa.com 316. Remote micro-service.aaa.com 316 may be one of many microservices associated with the application (service) “aaa.com” accessed at ISV server 310 (e.g., http://aaa.com). In one implementation, a sidecar 314 may be utilized with remote micro-service.aaa.com 316. Sidecar 314 may inject a cloud signed key, ISV cloud key 312, to remote micro-service.aaa.com 316.

FIG. 3B depicts a client device 320 hosting a local microservice, such as local micro-service.aaa.com 322. Local micro-service.aaa.com 322 may be the same microservice as remote micro-service.aaa.com 316, but deployed locally on client device 320. In implementations herein, a different key is used for the local micro-service.aaa.com 322 at the client device 320 than is used for the remote micro-service.aaa.com 316 at the ISV server 310. For example, a sidecar 326 operating in a confidential compute domain 325 can inject a Client-Signed-Key 328 to the local micro-service.aaa.com 322. In some implementations, the client device 320 can also adopt a remote attestation process to verify a key generated by the ISV server 310 of the application. For example, this remote attestation process may be utilized for cases where the ISV server 310 prefers to provide keys for each client device 320.

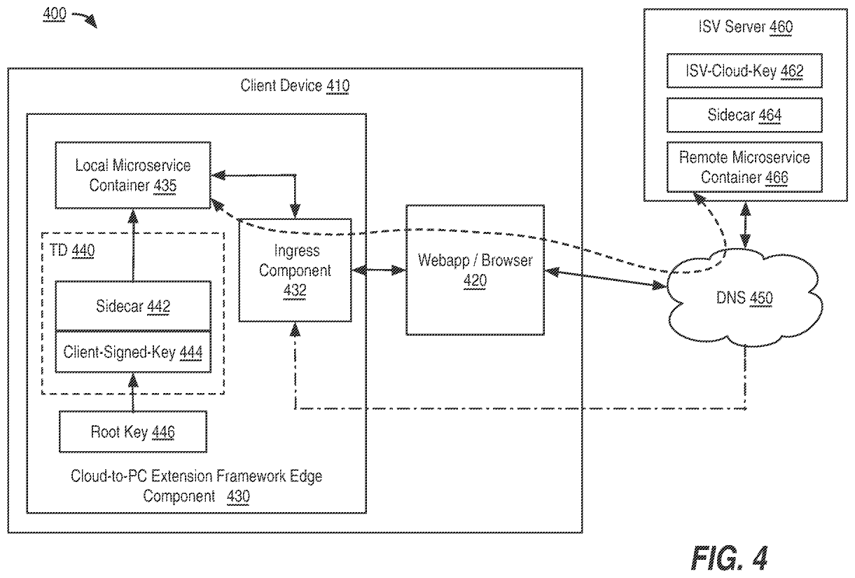

FIG. 4 is a block diagram depicting a networking system 400 implementing transparent transportation in a cloud-to-PC extension framework, in accordance with implementations herein. In one implementation, networking system 400 may be the same as networking system 100 described with respect to FIG. 1. As illustrated, networking system 400 include a client device 410 and an ISV server 460. In one implementation, client device 410 may the same as client device 102 of FIG. 1, computing device 200 of FIG. 2, and/or client device 320 of FIG. 3. In one implementation, ISV server 460 may the same as ISV server 106 of FIG. 1 and/or ISV server 310 of FIG. 3.

Networking system 400 provides for deploying a local microservice container 435 to host microservice functionality for an application hosted by ISV server 460. The cloud-to-PC extension framework edge component 430 operating on client device 410 is responsible for orchestrating and managing the deployment of the local microservice container 435. As part of deploying the local microservice container 435, the cloud-to-PC extension framework edge component 430 can establish a secure communication connection for transparent transportation of application data between the ISV server 460 and the local microservice container 435.

When the cloud-to-PC extension framework edge component 430 is initialized, it generates a Client-Signed-Root Key (root key 446) that is trusted by the client device 410. As discussed above, the cloud-to-PC extension framework edge component 430 manages and deploys local microservice container(s) 435 to host microservice functionality for a remote application of ISV server 460. The following example process details a workflow of the cloud-to-PC extension framework edge component 430.

During installation of the cloud-to-PC extension framework edge component 430, the cloud-to-PC extension framework edge component 430 generates the root key 446. During runtime of the cloud-to-PC extension framework edge component 430, the cloud-to-PC extension framework edge component 430 obtains an application manifest from a cloud-to-PC extension framework controller, such as cloud-to-PC extension framework controller 150 of FIG. 1. The application manifest defines the location to download the microservice container 435, and a method to inject keys.

The cloud-to-PC extension framework edge component 430 downloads the local microservice container 435 in accordance with the application manifest. Then, the cloud-to-PC extension framework edge component 430 initializes a pod for the local microservice container 435 and injects a sidecar 442 corresponding to the local microservice container 435.

The sidecar 442 utilizes the root key 446 to generate a client-signed-key 444 for the local microservice container 435. Then, the sidecar 442 injects the client-signed-key 444 (and/or any other certification data) to the local microservice container 435. In one implementation, the sidecar 442 is protected by a TD 440. In some implementations, other confidential compute architectures may be utilized to provide a confidential compute environment for the sidecar 442. In some implementation, the sidecar 442 can rotate/renew the client-signed-key 444 (or any other client certifications that are utilized).

Once the local microservice container 435 is ready, the cloud-to-PC extension framework edge component 430 can redirect any Domain Name System (DNS) 450 requests for the microservice to the local microservice container 435 via an ingress component 432. In some implementations, the webapp/browser 420 can setup a TLS connection to local microservice container 435. The certification for the local microservice container 435 is changed from cloud signed to client signed, but the client side's certification is also trusted by the webapp/browser 420. As a result, the transparent access for webapp/browser 420 to the microservice is supported without having to change the webapp/browser 420 and/or the microservice container 435.

As noted above, a sidecar, such as sidecar 442 and a sidecar 464 implemented at ISV server 460, can be used to inject the certifications for both the ISV server 460 (cloud) and client device 410 (client). For example, the sidecar 442 at client device 410 can inject the client-signed-key 444 into the local microservice container 435, while the sidecar 464 at the ISV server 460 can inject the ISV-cloud-key 462 into the remote microservice container 466. One type of sidecar is a service mesh. In one implementation, a service mesh can take over the data plane and control plane for the microservice 435 to help the microservice 435 focusing on tasks implementing its primary functionality.

As noted above, a confidential compute architecture domain, such as TD 440, can protect the sidecar 442 to secure the self-signed key or client-signed-key 444, which can be attested by the ISV server 460 through remote attestation. TDX is one example of a confidential compute architecture that can be utilized by implementations herein. However, other implementations can use other TEE (Trusted Execution Environment) protection methods to protect the sidecar 442, such as Intel® SGX, and so on.

With respect to the client-signed-key 444, the sidecar 442 obtains the Root Key 446, which is signed by the cloud-to-PC extension framework edge component 430, and obtains the hostname of the microservice (e.g., “micro-service.aaa.com”). Then, the sidecar 442 can generate the new key, client-signed-key 444, for local microservice container 435 with the Root Key 446.

With respect to remote attestation, if the ISV server 460 prefers to provide a separate key for each client device 410, the sidecar 442 can pull the ISV-signed-client-key, which may be defined in the application manifest. In one implementation, a TEE remote attestation process can allow the ISV server 4660 to be confident (e.g., verify) that their workloads deployed to client device 410 can be trusted and securely protected in a TEE, so that the ISV server 460 can attest the keys generated by client inside the TEE (e.g., issue an intermediate certificate for that that client), or directly secure deploys the client certificates and corresponding secret private keys to client through remote attestation method. After the sidecar 442 obtains the key, it injects the key to the local microservice container 435 and can be responsible for key rotation.

One example use case of implementations here is detailed below. The example use case is an online video editing case. In the example online video editing case, there is one micro-service “video background removal”. The webapp visits that service through a QUIC protocol. The webapp is then sends a video to the cloud background-removal service (microservice) and receives a background-removed video in response.

When implementing a cloud-to-PC extension framework, the background removal microservice could be operated locally at the client device, without sending the background information to the cloud. The cloud-to-PC extension framework can deploy the background removal microservice container on the client device. When the webapp seeks to visit the background removal microservice, this request can be redirected locally to the locally-deployed background removal microservice. Implementations herein provide for the establishment of a secure communication connection for the webapp to connect to the local background removal microservice through, for example, a QUIC protocol.

Embodiments may be provided, for example, as a computer program product which may include one or more machine-readable media having stored thereon machine executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMS, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

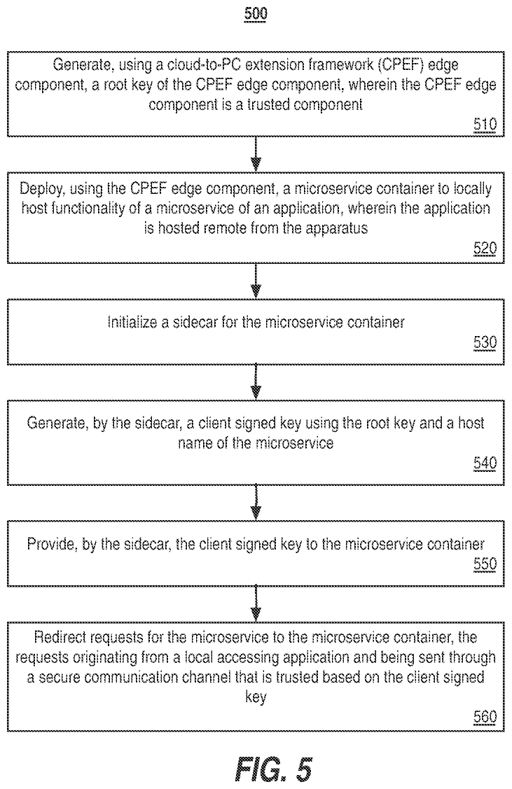

FIG. 5 is a flow diagram illustrating an embodiment of a method 500 for transparent transportation in cloud-to-PC extension framework using a locally-generated client signed key. Method 500 may be performed by processing logic that may comprise hardware (e.g., circuitry, dedicated logic, programmable logic, etc.), software (such as instructions run on a processing device), or a combination thereof. More particularly, the method 500 may be implemented in one or more modules as a set of logic instructions stored in a machine-or computer-readable storage medium (also referred to herein as a non-transitory computer-readable storage medium) such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

The process of method 500 is illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-4 may not be repeated or discussed hereafter. In one implementation, a computing device implementing cloud-to-PC extension framework edge component, such as processing device executing a cloud-to-PC extension framework edge component 120, 210, and/or 430 of FIGS. 1, 2, and 4, may perform method 500.

The example process of method 500 of FIG. 5 begins at block 510 where a processing device may generate, using a cloud-to-PC extension framework (CPEF) edge component, a root key of the CPEF edge component. In one implementation, the CPEF edge component is a trusted component. Then, at block 520, the processing device may deploy, using the CPEF edge component, a microservice container to locally host functionality of a microservice of an application. In one implementation, the application is hosted remote from the apparatus.

At block 530, the processing device may initialize a sidecar for the microservice container. Then, at block 540, the processing device may generate, by the sidecar, a client signed key using the root key and a host name of the microservice.

Subsequently, at block 550, the processing device may provide, by the sidecar, the client signed key to the microservice container. Lastly, at block 560, the processing device may redirect requests for the microservice to the microservice container. In one implementation, the requests originate from a local accessing application and are sent through a secure communication channel that is trusted based on the client signed key.

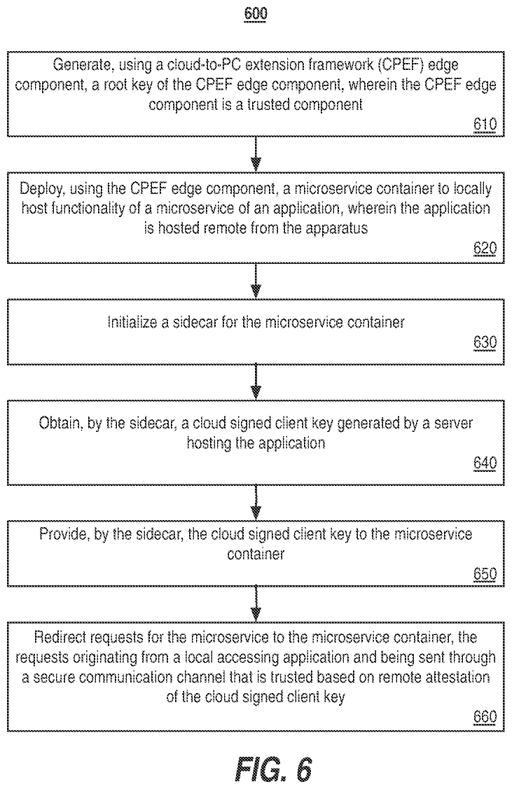

FIG. 6 is a flow diagram illustrating an embodiment of a method 600 for transparent transportation in cloud-to-PC extension framework using remote attestation. Method 600 may be performed by processing logic that may comprise hardware (e.g., circuitry, dedicated logic, programmable logic, etc.), software (such as instructions run on a processing device), or a combination thereof. More particularly, the method 600 may be implemented in one or more modules as a set of logic instructions stored in a machine- or computer-readable storage medium (also referred to herein as a non-transitory computer-readable storage medium) such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

The process of method 600 is illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-5 may not be repeated or discussed hereafter. In one implementation, a computing device implementing cloud-to-PC extension framework edge component, such as processing device executing a cloud-to-PC extension framework edge component 120, 210, and/or 430 of FIGS. 1, 2, and 4, may perform method 600.

The example process of method 600 of FIG. 6 begins at block 610 where a processing device may generate, using a cloud-to-PC extension framework (CPEF) edge component, a root key of the CPEF edge component. In one implementation, the CPEF edge component is a trusted component. Then, at block 620, the processing device may deploy, using the CPEF edge component, a microservice container to locally host functionality of a microservice of an application. In one implementation, the application is hosted remote from the apparatus.

At block 630, the processing device may initialize a sidecar for the microservice container. Then, at block 640, the processing device may obtain, by the sidecar, a cloud signed client key generated by a server hosting the application. Subsequently, at block 650, the processing device may provide, by the sidecar, the cloud signed client key to the microservice container. Lastly, at block 660, the processing device may redirect requests for the microservice to the microservice container. In one implementation, the requests originate from a local accessing application and are sent through a secure communication channel that is trusted based on remote attestation of the cloud signed client key.

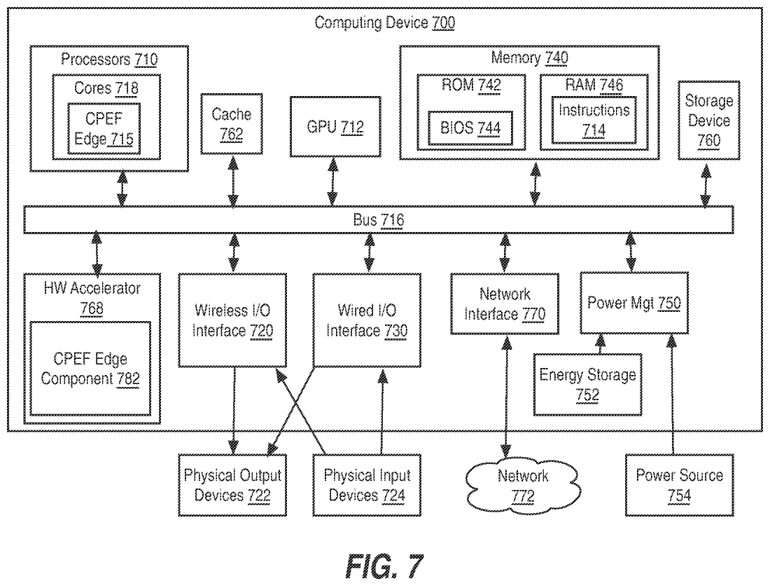

FIG. 7 is a schematic diagram of an illustrative electronic computing device 700 to enable transparent transportation in cloud-to-PC extension framework, in accordance with implementations herein. In some embodiments, the computing device 700 includes one or more processors 710 including one or more processor cores 718 including CPEF edge component 715, such as cloud-to-PC extension framework edge component 120, 210, and/or 430 described with respect to FIGS. 1, 2, and 4, respectively. In some embodiments, the one or more processor cores 718 use the CPEF edge component 715 to establish a secure communication channel for transparent transportation in cloud-to-PC extension orchestrator framework. In some embodiments, the computing device 700 includes a hardware accelerator 768, the hardware accelerator 768 including an CPEF edge component 782, such as cloud-to-PC extension framework edge component 120, 210, and/or 430 described with respect to FIGS. 1, 2, and 4, respectively. In some embodiments, the hardware accelerator 768 establishes a TEE to host the CPEF edge component 782. In some embodiments, the computing device is to provide transparent transportation in cloud-to-PC extension orchestrator framework, as provided in FIGS. 1-6.

The computing device 700 may additionally include one or more of the following: cache 762, a graphical processing unit (GPU) 712 (which may be the hardware accelerator in some implementations), a wireless input/output (I/O) interface 720, a wired I/O interface 730, system memory 740 (e.g., memory circuitry), power management circuitry 750, non-transitory storage device 760, and a network interface 770 for connection to a network 772. The following discussion provides a brief, general description of the components forming the illustrative computing device 700. Example, non-limiting computing devices 700 may include a desktop computing device, blade server device, workstation, or similar device or system.

In embodiments, the processor cores 718 are capable of executing machine-readable instruction sets 714, reading data and/or instruction sets 714 from one or more storage devices 760 and writing data to the one or more storage devices 760. Those skilled in the relevant art can appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The processor cores 718 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 700 includes a bus or similar communications link 716 that communicably couples and facilitates the exchange of information and/or data between various system components including the processor cores 718, the cache 762, the graphics processor circuitry 712, one or more wireless I/O interfaces 720, one or more wired I/O interfaces 730, one or more storage devices 760, and/or one or more network interfaces 770. The computing device 700 may be referred to in the singular herein, but this is not intended to limit the embodiments to a single computing device 700, since in certain embodiments, there may be more than one computing device 700 that incorporates, includes, or contains any number of communicably coupled, collocated, or remote networked circuits or devices.

The processor cores 718 may include any number, type, or combination of currently available or future developed devices capable of executing machine-readable instruction sets.

The processor cores 718 may include (or be coupled to) but are not limited to any current or future developed single-or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 7 are of conventional design. Consequently, such blocks are not described in further detail herein, as they can be understood by those skilled in the relevant art. The bus 716 that interconnects at least some of the components of the computing device 700 may employ any currently available or future developed serial or parallel bus structures or architectures.

The system memory 740 may include read-only memory (“ROM”) 742 and random access memory (“RAM”) 746. A portion of the ROM 742 may be used to store or otherwise retain a basic input/output system (“BIOS”) 744. The BIOS 744 provides basic functionality to the computing device 700, for example by causing the processor cores 718 to load and/or execute one or more machine-readable instruction sets 714. In embodiments, at least some of the one or more machine-readable instruction sets 714 cause at least a portion of the processor cores 718 to provide, create, produce, transition, and/or function as a dedicated, specific, and particular machine, for example a word processing machine, a digital image acquisition machine, a media playing machine, a gaming system, a communications device, a smartphone, or similar.

The computing device 700 may include at least one wireless input/output (I/O) interface 720. The at least one wireless I/O interface 720 may be communicably coupled to one or more physical output devices 722 (tactile devices, video displays, audio output devices, hardcopy output devices, etc.). The at least one wireless I/O interface 720 may communicably couple to one or more physical input devices 724 (pointing devices, touchscreens, keyboards, tactile devices, etc.). The at least one wireless I/O interface 720 may include any currently available or future developed wireless I/O interface. Example wireless I/O interfaces include, but are not limited to: BLUETOOTH®, near field communication (NFC), and similar.

The computing device 700 may include one or more wired input/output (I/O) interfaces 730. The at least one wired I/O interface 730 may be communicably coupled to one or more physical output devices 722 (tactile devices, video displays, audio output devices, hardcopy output devices, etc.). The at least one wired I/O interface 730 may be communicably coupled to one or more physical input devices 724 (pointing devices, touchscreens, keyboards, tactile devices, etc.). The wired I/O interface 730 may include any currently available or future developed I/O interface. Example wired I/O interfaces include, but are not limited to: universal serial bus (USB), IEEE 1394 (“FireWire”), and similar.

The computing device 700 may include one or more communicably coupled, non-transitory, data storage devices 760. The data storage devices 760 may include one or more hard disk drives (HDDs) and/or one or more solid-state storage devices (SSDs). The one or more data storage devices 760 may include any current or future developed storage appliances, network storage devices, and/or systems. Non-limiting examples of such data storage devices 760 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 760 may include one or more removable storage devices, such as one or more flash drives, flash memories, flash storage units, or similar appliances or devices capable of communicable coupling to and decoupling from the computing device 700.

The one or more data storage devices 760 may include interfaces or controllers (not shown) communicatively coupling the respective storage device or system to the bus 716. The one or more data storage devices 760 may store, retain, or otherwise contain machine-readable instruction sets, data structures, program modules, data stores, databases, logical structures, and/or other data useful to the processor cores 718 and/or graphics processor circuitry 712 and/or one or more applications executed on or by the processor cores 718 and/or graphics processor circuitry 712. In some instances, one or more data storage devices 760 may be communicably coupled to the processor cores 718, for example via the bus 716 or via one or more wired communications interfaces 730 (e.g., Universal Serial Bus or USB); one or more wireless communications interfaces 720 (e.g., Bluetooth®, Near Field Communication or NFC); and/or one or more network interfaces 770 (IEEE 802.3 or Ethernet, IEEE 802.11, or Wi-Fi®, etc.).

Processor-readable instruction sets 714 and other programs, applications, logic sets, and/or modules may be stored in whole or in part in the system memory 740. Such instruction sets 714 may be transferred, in whole or in part, from the one or more data storage devices 760. The instruction sets 714 may be loaded, stored, or otherwise retained in system memory 740, in whole or in part, during execution by the processor cores 718 and/or graphics processor circuitry 712.

The computing device 700 may include power management circuitry 750 that controls one or more operational aspects of the energy storage device 752. In embodiments, the energy storage device 752 may include one or more primary (i.e., non-rechargeable) or secondary (i.e., rechargeable) batteries or similar energy storage devices. In embodiments, the energy storage device 752 may include one or more supercapacitors or ultracapacitors. In embodiments, the power management circuitry 750 may alter, adjust, or control the flow of energy from an external power source 754 to the energy storage device 752 and/or to the computing device 700. The power source 754 may include, but is not limited to, a solar power system, a commercial electric grid, a portable generator, an external energy storage device, or any combination thereof.

For convenience, the processor cores 718, the graphics processor circuitry 712, the wireless I/O interface 720, the wired I/O interface 730, the storage device 760, and the network interface 770 are illustrated as communicatively coupled to each other via the bus 716, thereby providing connectivity between the above-described components. In alternative embodiments, the above-described components may be communicatively coupled in a different manner than illustrated in FIG. 7. For example, one or more of the above-described components may be directly coupled to other components, or may be coupled to each other, via one or more intermediary components (not shown). In another example, one or more of the above-described components may be integrated into the processor cores 718 and/or the graphics processor circuitry 712. In some embodiments, all or a portion of the bus 716 may be omitted and the components are coupled directly to each other using suitable wired or wireless connections.

The following examples pertain to further embodiments. Example 1 is an apparatus to facilitate transparent transportation in cloud-to-PC extension framework. The apparatus of Example 1 comprises one or more processors to: generate, using a cloud-to-personal computer (PC) extension framework (CPEF) edge component, a root key of the CPEF edge component, wherein the CPEF edge component is trusted by the one or more processors; deploy, using the CPEF edge component, a microservice container to locally host functionality of a microservice of an application, wherein the application is hosted remotely from the apparatus; initialize a sidecar for the microservice container; generate, by the sidecar, a client signed key using at least one of the root key and a hostname of the microservice; provide, by the sidecar, the client signed key to the microservice container; and redirect requests for the microservice to the microservice container, the requests originating from an accessing application of the apparatus, the requests redirected through a secure communication channel that is trusted based on the client signed key.

In Example 2, the subject matter of Example 1 can optionally include wherein the microservice container to deploy is identified in an application manifest provided to the CPEF edge component from a remote CPEF controller. In Example 3, the subject matter of any one of Examples 1-2 can optionally include wherein the sidecar is protected by a confidential compute architecture. In Example 4, the subject matter of any one of Examples 1-3 can optionally include wherein the confidential compute architecture comprises an Intel® Trusted Domain eXtensions® (TDX) confidential compute architecture, and wherein the sidecar is implemented in a trust domain (TD) of the TDX confidential compute architecture.

In Example 5, the subject matter of any one of Examples 1-4 can optionally include wherein the accessing application comprises at least one of a web application (webapp) or a browser application. In Example 6, the subject matter of any one of Examples 1-5 can optionally include wherein the sidecar is to at least one of rotate or renew the client-signed-key for the microservice container. In Example 7, the subject matter of any one of Examples 1-6 can optionally include wherein the sidecar is part of a service mesh of the application.

In Example 8, the subject matter of any one of Examples 1-7 can optionally include wherein the secure communication channel is established using at least one a QUIC protocol or a transport layer security (TLS) protocol. In Example 9, the subject matter of any one of Examples 1-8 can optionally include wherein the client-signed-key is provided by a server hosting the application and is obtained from an application manifest provided by a remote CPEF controller, and wherein the server utilizes remote attestation to verify the client-signed-key.

Example 10 is a method for facilitating transparent transportation in cloud-to-PC extension framework. The method of Example 10 can include generating, by one or more processors using a cloud-to-personal computer (PC) extension framework (CPEF) edge component, a root key of the CPEF edge component, wherein the CPEF edge component is trusted by the one or more processors; deploying, using the CPEF edge component, a microservice container to locally host functionality of a microservice of an application, wherein the application is hosted remotely from a computing device of the one or more processors; initializing a sidecar for the microservice container; generating, by the sidecar, a client signed key using at least one of the root key and a hostname of the microservice; providing, by the sidecar, the client signed key to the microservice container; and redirecting requests for the microservice to the microservice container, the requests originating from an accessing application of the computing device, the requests redirected through a secure communication channel that is trusted based on the client signed key.

In Example 11, the subject matter of Example 10 can optionally include wherein the microservice container to deploy is identified in an application manifest provided to the CPEF edge component from a remote CPEF controller. In Example 12, the subject matter of Examples 10-11 can optionally include wherein the sidecar is protected by a confidential compute architecture. In Example 13, the subject matter of Examples 10-12 can optionally include wherein the accessing application comprises at least one of a web application (webapp) or a browser application.

In Example 14, the subject matter of Examples 10-13 can optionally include wherein the sidecar is to at least one of rotate or renew the client-signed-key for the microservice container. In Example 15, the subject matter of Examples 10-14 can optionally include wherein the client-signed-key is provided by a server hosting the application and is obtained from an application manifest provided by a remote CPEF controller, and wherein the server utilizes remote attestation to verify the client-signed-key.

Example 16 is a non-transitory computer-readable storage medium for facilitating transparent transportation in cloud-to-PC extension framework. The non-transitory computer-readable storage medium of Example 16 having stored thereon executable computer program instructions that, when executed by one or more processors, cause the one or more processors to perform operations comprising: generating, by the one or more processors using a cloud-to-personal computer (PC) extension framework (CPEF) edge component, a root key of the CPEF edge component, wherein the CPEF edge component is trusted by the one or more processors; deploying, using the CPEF edge component, a microservice container to locally host functionality of a microservice of an application, wherein the application is hosted remotely from a computing device of the one or more processors; initializing a sidecar for the microservice container; generating, by the sidecar, a client signed key using at least one of the root key and a hostname of the microservice; providing, by the sidecar, the client signed key to the microservice container; and redirecting requests for the microservice to the microservice container, the requests originating from an accessing application of the computing device, the requests redirected through a secure communication channel that is trusted based on the client signed key.

In Example 17, the subject matter of Example 16 can optionally include wherein the microservice container to deploy is identified in an application manifest provided to the CPEF edge component from a remote CPEF controller. In Example 18, the subject matter of Examples 16-17 can optionally include wherein the sidecar is protected by a confidential compute architecture.

In Example 19, the subject matter of Examples 16-18 can optionally include wherein the sidecar is to at least one of rotate or renew the client-signed-key for the microservice container. In Example 20, the subject matter of Examples 16-19 can optionally include wherein the client-signed-key is provided by a server hosting the application and is obtained from an application manifest provided by a remote CPEF controller, and wherein the server utilizes remote attestation to verify the client-signed-key.

Example 21 is a system for facilitating transparent transportation in cloud-to-PC extension framework. The system of Example 21 can optionally include a memory to store a block of data, and one or more processors communicably coupled to the memory to: generate, using a cloud-to-personal computer (PC) extension framework (CPEF) edge component, a root key of the CPEF edge component, wherein the CPEF edge component is trusted by the one or more processors; deploy, using the CPEF edge component, a microservice container to locally host functionality of a microservice of an application, wherein the application is hosted remotely from the apparatus; initialize a sidecar for the microservice container; generate, by the sidecar, a client signed key using at least one of the root key and a hostname of the microservice; provide, by the sidecar, the client signed key to the microservice container; and redirect requests for the microservice to the microservice container, the requests originating from an accessing application of the apparatus, the requests redirected through a secure communication channel that is trusted based on the client signed key.

In Example 22, the subject matter of Example 21 can optionally include wherein the microservice container to deploy is identified in an application manifest provided to the CPEF edge component from a remote CPEF controller. In Example 23, the subject matter of any one of Examples 21-22 can optionally include wherein the sidecar is protected by a confidential compute architecture. In Example 24, the subject matter of any one of Examples 21-23 can optionally include wherein the confidential compute architecture comprises an Intel® Trusted Domain extensions® (TDX) confidential compute architecture, and wherein the sidecar is implemented in a trust domain (TD) of the TDX confidential compute architecture.

In Example 25, the subject matter of any one of Examples 21-24 can optionally include wherein the accessing application comprises at least one of a web application (webapp) or a browser application. In Example 26, the subject matter of any one of Examples 21-25 can optionally include wherein the sidecar is to at least one of rotate or renew the client-signed-key for the microservice container. In Example 27, the subject matter of any one of Examples 21-26 can optionally include wherein the sidecar is part of a service mesh of the application.

In Example 28, the subject matter of any one of Examples 21-27 can optionally include wherein the secure communication channel is established using at least one a QUIC protocol or a transport layer security (TLS) protocol. In Example 29, the subject matter of any one of Examples 21-28 can optionally include wherein the client-signed-key is provided by a server hosting the application and is obtained from an application manifest provided by a remote CPEF controller, and wherein the server utilizes remote attestation to verify the client-signed-key.

Example 30 is an apparatus for facilitating transparent transportation in cloud-to-PC extension framework, comprising means for generating, using a cloud-to-personal computer (PC) extension framework (CPEF) edge component, a root key of the CPEF edge component, wherein the CPEF edge component is trusted by the one or more processors; means for deploying, using the CPEF edge component, a microservice container to locally host functionality of a microservice of an application, wherein the application is hosted remotely from a computing device of the one or more processors; means for initializing a sidecar for the microservice container; generating, by the sidecar, a client signed key using at least one of the root key and a hostname of the microservice; means for providing, using the sidecar, the client signed key to the microservice container; and means for redirecting requests for the microservice to the microservice container, the requests originating from an accessing application of the computing device, the requests redirected through a secure communication channel that is trusted based on the client signed key. In Example 31, the subject matter of Example 30 can optionally include the apparatus further configured to perform the method of any one of the Examples 11 to 15.

Example 32 is at least one machine readable medium comprising a plurality of instructions that in response to being executed on a computing device, cause the computing device to carry out a method according to any one of Examples 10-15. Example 33 is an apparatus for facilitating transparent transportation in cloud-to-PC extension framework, configured to perform the method of any one of Examples 10-15. Example 34 is an apparatus for facilitating transparent transportation in cloud-to-PC extension framework, comprising means for performing the method of any one of Examples 10-15. Specifics in the Examples may be used anywhere in one or more embodiments.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium (e.g., non-transitory computer-readable storage medium) having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments. The various appearances of “an embodiment,” “one embodiment,” or “some embodiments” are not all referring to the same embodiments. It should be appreciated that in the foregoing description of example embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments utilize more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

The foregoing description and drawings are to be regarded in an illustrative rather than a restrictive sense. Persons skilled in the art can understand that various modifications and changes may be made to the embodiments described herein without departing from the broader spirit and scope of the features set forth in the appended claims.

What is claimed is:

1. An apparatus comprising:
one or more processors to:
generate, using a cloud-to-personal computer (PC) extension framework (CPEF) edge component, a root key of the CPEF edge component, wherein the CPEF edge component is trusted by the one or more processors;
deploy, using the CPEF edge component, a microservice container to locally host functionality of a microservice of an application, wherein the application is hosted remotely from the apparatus;
initialize a sidecar for the microservice container;
generate, by the sidecar, a client signed key using at least one of the root key and a hostname of the microservice;
provide, by the sidecar, the client signed key to the microservice container; and
redirect requests for the microservice to the microservice container, the requests originating from an accessing application of the apparatus, the requests redirected through a secure communication channel that is trusted based on the client signed key.

2. The apparatus of claim 1, wherein the microservice container to deploy is identified in an application manifest provided to the CPEF edge component from a remote CPEF controller.

3. The apparatus of claim 1, wherein the sidecar is protected by a confidential compute architecture.

4. The apparatus of claim 3, wherein the confidential compute architecture comprises an Intel® Trusted Domain eXtensions® (TDX) confidential compute architecture, and wherein the sidecar is implemented in a trust domain (TD) of the TDX confidential compute architecture.

5. The apparatus of claim 1, wherein the accessing application comprises at least one of a web application (webapp) or a browser application.

6. The apparatus of claim 1, wherein the sidecar is to at least one of rotate or renew the client-signed-key for the microservice container.

7. The apparatus of claim 1, wherein the sidecar is part of a service mesh of the application.

8. The apparatus of claim 1, wherein the secure communication channel is established using at least one a QUIC protocol or a transport layer security (TLS) protocol.

9. The apparatus of claim 1, wherein the client-signed-key is provided by a server hosting the application and is obtained from an application manifest provided by a remote CPEF controller, and wherein the server utilizes remote attestation to verify the client-signed-key.

10. A method comprising:
generating, by one or more processors using a cloud-to-personal computer (PC) extension framework (CPEF) edge component, a root key of the CPEF edge component, wherein the CPEF edge component is trusted by the one or more processors;
deploying, using the CPEF edge component, a microservice container to locally host functionality of a microservice of an application, wherein the application is hosted remotely from a computing device of the one or more processors;
initializing a sidecar for the microservice container;
generating, by the sidecar, a client signed key using at least one of the root key and a hostname of the microservice;
providing, by the sidecar, the client signed key to the microservice container; and
redirecting requests for the microservice to the microservice container, the requests originating from an accessing application of the computing device, the requests redirected through a secure communication channel that is trusted based on the client signed key.

11. The method of claim 10, wherein the microservice container to deploy is identified in an application manifest provided to the CPEF edge component from a remote CPEF controller.

12. The method of claim 10, wherein the sidecar is protected by a confidential compute architecture.

13. The method of claim 10, wherein the accessing application comprises at least one of a web application (webapp) or a browser application.

14. The method of claim 10, wherein the sidecar is to at least one of rotate or renew the client-signed-key for the microservice container.

15. The method of claim 10, wherein the client-signed-key is provided by a server hosting the application and is obtained from an application manifest provided by a remote CPEF controller, and wherein the server utilizes remote attestation to verify the client-signed-key.

16. A non-transitory computer-readable storage medium having stored thereon executable computer program instructions that, when executed by one or more processors, cause the one or more processors to perform operations comprising:
generating, by the one or more processors using a cloud-to-personal computer (PC) extension framework (CPEF) edge component, a root key of the CPEF edge component, wherein the CPEF edge component is trusted by the one or more processors;
deploying, using the CPEF edge component, a microservice container to locally host functionality of a microservice of an application, wherein the application is hosted remotely from a computing device of the one or more processors;
initializing a sidecar for the microservice container;
generating, by the sidecar, a client signed key using at least one of the root key and a hostname of the microservice;
providing, by the sidecar, the client signed key to the microservice container; and
redirecting requests for the microservice to the microservice container, the requests originating from an accessing application of the computing device, the requests redirected through a secure communication channel that is trusted based on the client signed key.

17. The non-transitory computer-readable storage medium of claim 16, wherein the microservice container to deploy is identified in an application manifest provided to the CPEF edge component from a remote CPEF controller.

18. The non-transitory computer-readable storage medium of claim 16, wherein the sidecar is protected by a confidential compute architecture.

19. The non-transitory computer-readable storage medium of claim 16, wherein the sidecar is to at least one of rotate or renew the client-signed-key for the microservice container.

20. The non-transitory computer-readable storage medium of claim 16, wherein the client-signed-key is provided by a server hosting the application and is obtained from an application manifest provided by a remote CPEF controller, and wherein the server utilizes remote attestation to verify the client-signed-key.
